(19) United States
(12) Patent Application Publication
(10) Pub. No.: US 2005/0024690 A1
(43) Pub. Date: Feb. 3, 2005

(54) Pen with tag reader and navigation system

(76) Inventors: Carl E. Picciotto, Menlo Park, CA (US); Steven T. Rosenberg, Palo Alto, CA (US); Hoyle Curtis, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/632,770

(22) Filed: Jul. 31, 2003

(51) Int. Cl. G06F 15/00

(52) U.S. Cl. 358/472; 358/473; 358/1.15

(57) ABSTRACT

A digitizing pen has a pen body with a writing tip for handwriting on a sheet of paper. An optical sensor disposed in the pen body images a writing surface of the sheet of paper. A tag-recognition reader is connected to the optical sensor, and gathers location information from data encoded on at least one tag positioned on the writing surface. A velocity reader is connected to the optical sensor, and gathers speed and relative direction information of the writing tip over the writing surface. A processor connected to receive the tag location, writing-tip speed, and writing-tip relative direction information, can then compute a series of locations on the writing surface visited by the writing tip.

### BACKGROUND OF EMBODIMENTS OF THE PRESENT INVENTION

1. Field of Embodiments of the Present Invention

Embodiments of the present invention relates to digitizers and more particularly to a digitizing pen that is adapted to perform tasks such as the digitization of handwriting and digital domain completion of paper forms. The pen assists in these functions by reading tags that are present on specially printed paper and to locating itself between tags by an on-board position-locating system.

2. Related Art

Navigational schemes to determine the position of a sensor array are used in a variety of applications. Navigational schemes are used to correlate images captured by a scanning device or to determine the position of a cursor control device such as a mouse. A hand scanner will typically acquire image data from a two-dimensional array of photosensitive elements that effectively map an image of an original document into a pixel data array. However, accurate array position information is required to achieve a useful degree of correlation between the original and the pixel data array. Navigational schemes are also useful so that swaths of scanned images can be collected by a narrow width scanner, and then stitched together into images that resemble the original image. Various mechanical, electromechanical and optoelectronic position-locating schemes have been proposed to address the issue of array location.

U.S. Pat. Nos. 5,578,813 and 5,644,139, issued to Ross R. Allen, et al., describe scanner position-locating techniques and suggest a range of position-locating solutions. E.g., track balls, encoder wheels, accelerometers providing an on-board position-locating platform, and the remote sensing of fields, waves or beams. This patent also discusses the use of optical readers in which pixel values are operated upon by processing elements to determine a mapping of image data. The processing elements operate on a particular pixel and its nearest neighbors to produce an array of correlation values at each pixel location. The correlation values are based on a comparison between a current image and a stored image representing a known position. The use of both coherent and incoherent light sources is suggested for the purpose of imaging inherent features present on a target surface such as a paper surface.

U.S. Pat. No. 5,729,008, assigned to Hewlett-Packard, teaches methods for tracking the relative movement between a hand scanner and a scanned paper sheet by correlating signals from an array of photoelements captured by a position-locating sensor built into a scanner. Relative movement is tracked by determining a correlation between the signals of a first frame and a second frame. An overall correlation is determined by summing individual correlations along eight directions of motions in a plane, each rotated from the previous by 45 degrees.

Ever more sophisticated approaches to scanner position-locating processing and algorithms are seen, for example in Hewlett-Packard's U.S. Pat. Nos. 6,002,124, 6049338, 6005681, 6195475, and 6249360.

U.S. Pat. No. 6,233,368 assigned to Agilent Technologies, Inc. shows how a CMOS digital integrated circuit can capture an image, digitize the image and process it, substantially in the digital domain. The chip includes a photocell array, an analog-to-digital converter, filter circuitry for edge and contrast enhancement, compression circuitry for reducing storage needs, correlation circuitry for generating a result surface, interpolation circuitry for mapping the result surface into x and y coordinates and an interface.

The position-locating of an optical mouse is illustrated in U.S. Pat. No. 6,433,780 issued to Agilent Technologies, Inc and this patent is also incorporated by reference. This patent explains how pixelated imaging of an IR or other light source can be used to solve unique and particular position-locating issues that pertain to a computer mouse. In this document the term pen is used broadly to mean both conventional ink pen and according to the context in which it is used, any of a variety of digitizing or data capture devices resembling or having physical dimensions similar to an ink pen.

Digitizing pens, digitizing tablet devices, and optoelectronic mice, are conventionally capable of capturing a position or location on a two dimensional surface. Digitizing pens are known that recognize various kinds of tag images that are printed on paper, often invisibly to the naked eye. However, to recognize handwriting or otherwise achieve fine resolution, the tags have to be very close together. For example, see Australian patent 761509 issued to Silverbrook Research Pty. Limited. This approach requires both large numbers of individually numbered tags and special adapted printing equipment. Digitizing tablet devices use, for example, ultrasound to locate the pen in space but are cumbersome and heavy. The optoelectronic mouse has the advantage of providing user feedback in the form of the mouse's cursor on the screen. Without the video feedback providing user correction, the mouse would be less useful. Further, the mouse can not be conveniently used as a plain paper writing instrument, nor can it deposit ink as required, for example, in the making of a signature.

Various schemes have been proposed for printing ordinary paper with generally invisible data carrying tags that can be read by a digitizing pen. Uses for such a device include handwriting and signature capture, and the digital completion of paper forms. For example, a number encoded by a tag printed in infrared reflective ink is mapped by a computer to the tag's location on a piece of paper. The piece of paper in this example is a form. The form has a box labeled “place an x in the box if you wish to receive more information about this product”. The box has printed within its boundaries, one or more such tag images. A computer using the captured tag image or the encoded number can resort to the aforesaid mapping to determine that the pen has made contact with the paper, in the specific box used in the example. This indicates that the user of the pen wishes to receive more information. In this type of scheme the only data being captured by the pen is data provided by the tag or tags.

In this example, neither the number of tags on the paper or the absolute location of the pen is of any importance. The usefulness of the combination of pen, computer and tag printed paper is that it can recognize the number encoded by a single tag and determine that a user has made a particular request.

Similar data capture technology can be used to trace a path, over the surface of the paper. When the spatial density of uniquely numbered and mapped tags is sufficiently high, a combination of digitizing pen and processing power can read a series of tags traced by the tip of the pen and with reference to either an algorithm or a map, recreate a path that is at least indicative of a pen stroke, an instance of handwriting or person's signature (or other complex drawing curve). However, the number of tags required to perform this task complicates the scheme from a number of perspectives. Devices of this type have utility in capturing signatures as well as serving as data capture devices for signature recognition and authentic ion software.

### SUMMARY OF EMBODIMENTS OF THE PRESENT INVENTION

Embodiments of the present invention provide a pen style device that combines an optoelectronic tag reading system and position-locating hardware features that allow the pen to locate itself between tags. A digitizing pen embodiment of the present invention has a pen body with a writing tip for handwriting on a sheet of paper. An optical sensor disposed in the pen body images a writing surface of the sheet of paper. A tag-recognition reader is connected to the optical sensor, and gathers location information from data encoded on at least one tag positioned on the writing surface. A velocity reader is connected to the optical sensor, and gathers speed and relative direction information of the writing tip over the writing surface. A processor connected to receive the tag location, writing-tip speed, and writing-tip relative direction information, can then compute a series of locations on the writing surface visited by the writing tip.

In some embodiments of the present invention there is provided a digitizing pen having a surface contacting tip in combination with an optical tag sensor for capturing tag data and a position-locating system for providing location information between tags

In other embodiments, the position-locating system includes an optical reader, a light, an array of photodetectors, and a processor. The light provides, at a grazing angle, a source of illumination at the tip. The optical reader collects reflected light from the light and focuses it on the photodetectors. The photodetectors capture surface features and produce a sequence of digital frames corresponding to those features. The processor computes location information by recognizing features in the video images.

In alternate embodiments the pen's tip further comprises a ball for depositing ink and the position-locating system obtains a sequence of images of an ink surface on the ball and extracts location information from the sequence.

### BRIEF DESCRIPTION OF THE DRAWINGS

FIG. 1 is a schematic and perspective diagram of a pen embodiment of the present invention;

FIG. 2 is a functional block diagram of a pen system embodiment of the present invention; and

FIG. 3 is a flow chart of a pen-position-locating method embodiment of the present invention.

### DETAILED DESCRIPTION OF EMBODIMENTS OF THE PRESENT INVENTION

Digitizing pen embodiments of the present invention allow a user to write on paper and to fill out forms while capturing the input electronically for data input and personal-signature recognition or verification. The pen is instrumented such that it can discern its relative location on what appears to be ordinary paper, and thus avoids the electronic tablet required for digitizing tablet systems.

In fact, the paper is populated with coded markers that include data related to where the markers are on the paper. Such markers can be visible, or printed with inks that respond only to infrared or ultraviolet. The pen is further able to see the fibers of the paper sweep by, and this is used to detect the direction and velocity of the pen point over the paper surface. Encountering a coded marker or tag allows the system to interpolate and extrapolate pen movements, and to fix absolute locations on the paper. It is therefore possible to capture the characteristic movements of a writer's signature in-the-making, and to identify where the pen is on the paper. For example, a preprinted form with boxes would allow a character or handwriting recognition job to be limited to searching the vocabulary appropriate to a particular box on a form.

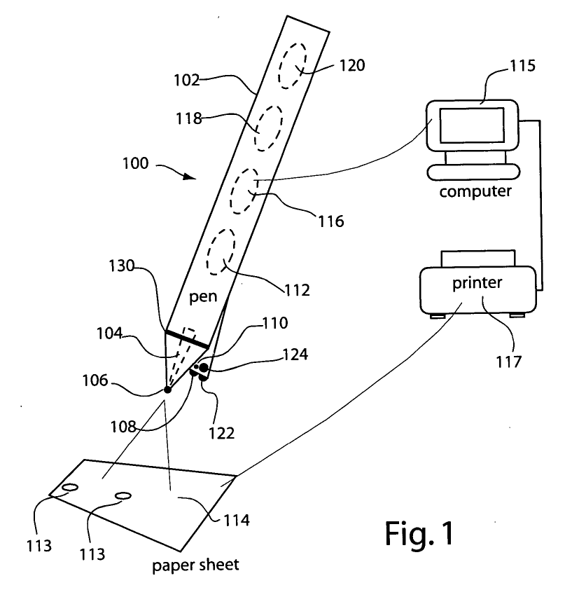

FIG. 1 represents a digitizing pen embodiment of the present invention, referred to herein by the general reference numeral 100, comprises a pen body 102 housing an ink cartridge 104, and a writing ball 106 at the tip. The body 102 further supports an optical tag reader comprising an optical tag sensor 108, a light 110, and a processor 112. These are used read location information from a coded tag 113 printed on a paper sheet 114. Such information is forwarded to a computer 115 for signature recognition and/or data input. The transmission can be wire-tethered or wireless, and either be raw data pen strokes, or even recognized character and word information. The coded tag 113 includes position information related to its unique location on the page, and is typically one of several. The paper sheet 114 has fibers or texture that can be imaged by the pen 100, so imaging their relative movement can be used to discern the relative speed and direction of the pen over the paper.

The tag sensor 108 may implemented with a 215×215 pixel CCD type device such as marketed by Matsushita Electronic Corporation and described in a paper by Itakura, et al. “A 1 mm 50k-pixel IT CCD Image Sensor for Miniature Camera System”, IEEE Transactions on Electronic Devices, Vol. 47, Number 1, January 2000. The sensor may also be a CMOS chip device, such as the one described in U.S. Pat. No. 6,233,368.

Each captured tag image is interpreted by digital processor 112, and data relating to the tag image or the actual number encoded by it is transmitted to user computer 115. Communications between the pen 100 and the user's computer 115 can be made by a wire or by wireless network device 116 such as a WiFi™ or Bluetooth™ transmitter/receiver located within the pen. In the alternative, processors 112 and 120 store captured or processed data into memory 118 for later use or transmission to computer 115.

The pen 100 further includes a position-locating sensor 122 to provide location data between instances of tag recognition, e.g., by interpolation or extrapolation. Such position-locating assembly comprises motion processor 120, an optical sensor 122, and a light 124. Motion processor 120 computes the speed and direction of the pen tip 106 over paper sheet 114 between tags 113. The sensor may be a CCD type device such as the 215×215 pixel produced by Matsushita Electronic Corporation and described in a paper by Itakura, et al. “A 1 mm 50k-pixel IT CCD Image Sensor for Miniature Camera System”, IEEE Transactions on Electronic Devices, Vol. 47, Number 1, January 2000. The sensor may also be a CMOS chip device such as the one described in U.S. Pat. No. 6,233,368. The CMOS device referred to is a single chip integrated circuit having a photo cell array for capturing an image and generating a representative analogue signal, and an on-chip digital signal processor providing an analogue to digital converter, filter circuitry including spatial filters for edge and contrast enhancement, compression circuitry, correlation circuitry and interpolation circuitry for mapping the result surface into x-y coordinates.

Optical position-locating may be achieved with the type of illumination, feature sensing and correlation solutions, e.g., as described in U.S. Pat. No. 6,433,780, issued Aug. 13, 2002. Surface features inherent to the navigated surface may be side illuminated with an infrared light emitting diode (LED) 124. By illuminating the paper sheet below the position-locating sensor's optics 122 from the side, at a grazing angle of e.g., 5-20 degrees, a wide variety of surface highlights and shadows, textures and fibers maybe detected and used for position-locating purposes. Coherent light from a laser can also be used by tracking speckle patterns in any reflected light.

The infrared light reflected back from the light 124 is focused onto a photodetector array 122. The size of the image projected onto the photo detectors may be magnified by a lens if needed. Ideally, there will be several photodetectors per surface feature and the size of the photodetector array will be large enough to capture several surface features. In this way, images of surface features, such as paper fibers will produce translated patterns of pixel information as the pen 100 moves. The responses of the individual photodetectors are digitized and stored as a frame to memory, either locally or over a network to the user's computer 115. Location tracking is possible by comparing sample frames with previously captured reference frames.

One method for extracting position-locating tracking or movement information from the comparison of the sample and reference frames is described in U.S. Pat. No. 6,433,780. A “hold feature” is further described that provides for the suspension of movement signals according to pre-established indicators, e.g., that the pen 100 has been lifted off the surface. For example, excessive rates of movement or “flatness” in the sample frame, or the absence of adequate reflected illumination in an optical mouse indicate the pen is off the paper. Such can be used to stop the cursor on the computer screen. When a next proper correlation occurs, the cursor movement is allowed to resume moving from its last location. In embodiments of the present invention, a “hold” event may be interpreted as occurring when the pen is lifted from the writing surface. In the case of pen motion and unlike mouse motion, the traced path may be deemed terminated and a new path is initiated at the location of the next tag that is correctly identified by the tag sensing system.

In one embodiment of the present invention, the optical position-locating system acquires an image from one side of the ink ball 106 to detect contact and movement on the paper. This avoids the difficulties associated by variations in angle or distance between the surface and the pen's position-locating optics. In some embodiments, such image is acquired from the backside of the rolling ball, near the user's writing hand. The surface of the ink on the ball can provide significant motion and direction indicia. It may be useful to include a pressure or proximity sensor to determine when the pen has been lifted off the paper for the purpose of determining when a path has terminated and initiated again. Path initiation and termination can also be interpolated and/or extrapolated by using tag data to pin the fixed locations.

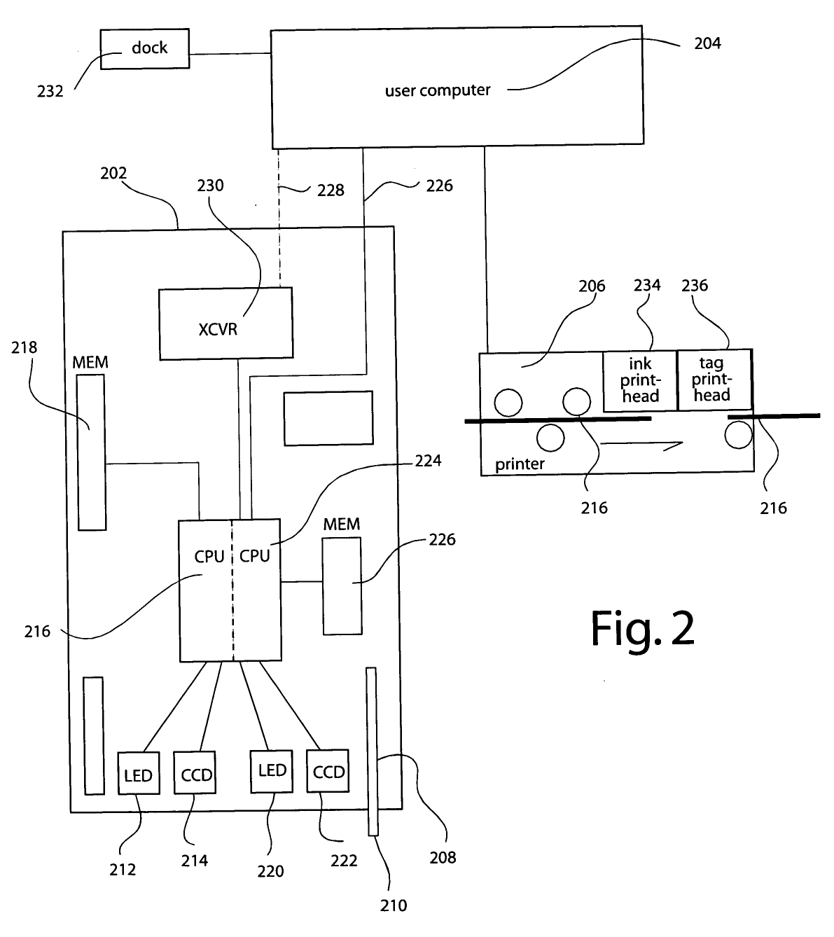

FIG. 2 represents a handheld digitizing pen system embodiment of the present invention, and is referred to herein by the general reference numeral 200. The digitizing pen system 200 includes a handheld digitizing pen 202 that communicates pen stroke information to a user computer 204 connected to a printer 206.

The handheld digitizing pen 202 has an ink cartridge 208 equipped with writing tip 210. Two independent optical processing systems are included. A first is a tag-location processing system that includes a light 212 for illuminating optical location tags for a tag camera 214. Such tags may made to be only visible in the infrared or ultraviolet, e.g., to make them less obnoxious to the user. A tag-location processor 216 interprets the optically encoded data it receives from the tags being viewed to discern the unique location of that tag on the paper. A memory 218 is used to store the results for later processing or transmission.

A second optical processing system is a pen-movement processing system that includes a light 220 for illuminating the paper for a movement camera 222. Alternatively, camera 222 may be focused on writing tip 210. A pen-motion processor 224 interprets the optical data it receives from the paper being viewed during the pen's motion on the paper. A memory 226 is used to store the results for later processing or transmission.

Motion and location results may be communicated to user computer 204 using a wire tether 226, or wirelessly over a radio link 228 supported by a transceiver 230. Or, a docking station 232 may be used to post-process batch data from memories 218 and 226 when the pen is put away.

The printer 206 can be used for both regular print jobs and tag-marking jobs. A sheet of paper 234 can be printed with ordinary ink by a traditional printhead 234. For example, a fill-in-the-blanks form can be prepared. The sheet of paper is then populated with location tags by printheads 236 to create a special sheet 238 with location tags for digitizing pen use. Such sheet 238 is the equivalent of paper 114 with tags 113 in FIG. 1.

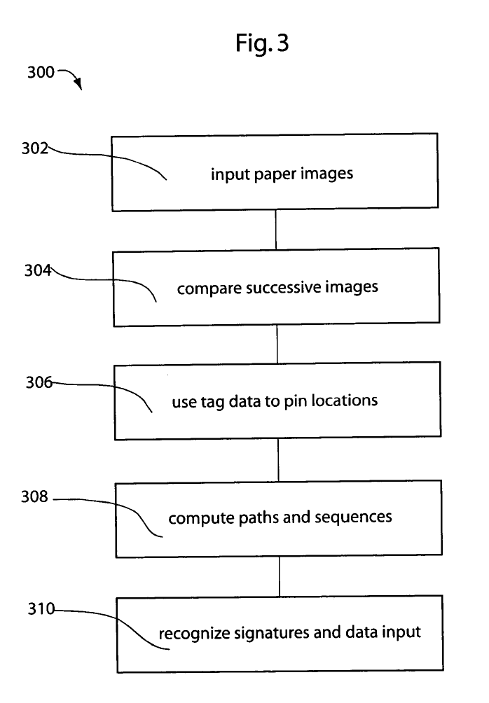

FIG. 3 represents a digitizing pen method embodiment of the present invention, and is referred to herein by the general reference numeral 300. The method 300 begins with a step 302 that inputs images from a pen-carried camera. A step 304 uses successive images taken over time to discern relative direction and speed of the pen in contact with the paper. When location tags on the paper are encountered, a step 306 uses the tag location information to pin the strokes recognized and to calibrate direction, distance, and speed only estimated beforehand. Obviously, the denser the population of tags are on the paper, the more often will such calibrations be able to occur. A step 308 computes the paths and sequences of the pen strokes, e.g., in a step 310 to verify a personal-signature or to recognize a data input. Such data input can be interpreted according to the pen's computed location, e.g., a particular “yes” box on a question form.

It is in the user's computer 115 or within the processing capability of the pen itself that the tag data and location information provided by the position-locating system is combined 306. The combination is capable of rendering an accurate digital representation of a path covered by the pen while in contact with the paper. Captured representations of signatures may be used, for example in conjunction with signature recognition software for the purpose of identifying people according to stored versions of their signatures. Captured tag data or combined tag and position-locating data may be used to identify a region on a paper sheet where the pen 100 is being used to mark. This constraining data may be used to reduce the recognition uncertainty, and therefore make the job of interpreting input strokes easier by limiting the class or kinds of strokes that constitute a valid entry. For example, some sections may require only a “yes” or “no” pen input. A user input can only be a “yes” or “no”, other interpretations are invalid.

The Patents and Articles mentioned herein are all incorporated by reference as if fully set forth here.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A digitizing pen, comprising:
a pen body with a writing tip for handwriting on a sheet of paper;
an optical sensor for imaging a writing surface of said sheet of paper and that is disposed in the pen body;
a tag-recognition reader connected to the optical sensor, and for gathering location information from data encoded on at least one tag positioned on said writing surface;
a velocity reader connected to the optical sensor, and for gathering speed and relative direction information of said writing tip over said writing surface; and
a processor connected to receive said tag location, writing-tip speed, and writing-tip relative direction information, and for computing a series of locations on said writing surface visited by said writing tip.

2. The pen of claim 1, wherein:
the optical sensor comprises an optical reader, a light, an array of photodetectors and a processor;
the light providing, at a grazing angle, a source of light on or below the tip;
the optical reader collecting reflected light from the light and focusing it on the photodetectors;
the photodetectors adapted to capture surface features and produce a sequence of digital frames corresponding to those features; and
the processor being adapted to yield location information by comparing frames from the sequence.

3. The pen of claim 1, wherein:
the tip further comprises a ball for depositing ink; and
the processor obtains a sequence of images of an ink surface on the ball and extracts location information from the sequence.

4. A method for digitizing a path having an initiation point and termination point, the path created by the movement of a pen tip over a surface printed with tags encoded with data, the method comprising the steps of:
capturing instances of tag data by using an optoelectronic tag sensor carried by the pen;
obtaining location information between the instances by using a position-locating system carried by the pen; and
combining tag data and location information to construct a digital representation of the path.

5. The method of claim 4, wherein:
determining the initiation point and termination point of a path is interpolated and extrapolated from tag data.

6. The method of claim 4, wherein:
the position-locating system is an optical reader comprising an optical reader, a light, an array of photodetectors and a processor.

7. The method of claim 4, wherein:
the tip further comprises a ball for depositing ink; and
the position-locating system obtains a sequence of images of an ink surface on the ball and extracts the location information from the sequence.

8. A method for capturing a signature created by the movement of a pen tip over a surface printed with tags encoded with data, the method comprising the steps of:
capturing instances of tag data by using an optoelectronic tag sensor carried by the pen;
obtaining location information between the instances by using a position-locating system carried by the pen;
combining tag data and location information to construct a digital representation of the path.

9. The method of claim 8, wherein:
determining the initiation point and termination point of the path is done by using the position-locating system or tag data.

10. The method of claim 8, wherein:
the position-locating system is an optical reader comprising an optical reader, a light, an array of photodetectors and a processor.

11. The method of claim 8, wherein:
the tip further comprises a ball for depositing ink; and the position-locating system obtains a sequence of images of an ink surface on the ball and extracts the location information from the sequence.

12. The pen of claim 2, wherein:
the light provides a source of coherent light and the position-locating system captures surface features by detecting specular reflection.

13. The pen of claim 2, wherein:
the grazing angle is 5 to 20 degrees.

14. The pen of claim 2, wherein:
tag data and location information are transmitted from the pen to a user's computer over a wireless network.

15. The method of claim 4, wherein:
the light provides a source of coherent light and the position-locating system captures surface features by detecting specular reflection.

16. The method of claim 8, wherein:
the light provides a source of coherent light and the position-locating system captures surface features by detecting specular reflection.

17. A pen and printer for capturing a digital record of a pen's location on a paper, comprising:
a digitizing pen having a surface contacting tip, an optical tag sensor for capturing tag data, a position-locating system for providing location information between tags, the pen also having transmission hardware for supplying tag data and location information to a computer; and
a printer for adding tags onto an already printed surface, which tags can be read by the pen but not by the naked eye.

18. The pen and printer of claim 17, wherein:
the position-locating system is an optical reader comprising an optical reader, a light, an array of photodetectors and a processor;
the light providing, at a grazing angle, a source of light on or below the tip;
the optical reader collecting reflected light from the light and focusing it on the photodetectors;
the photodetectors adapted to capture surface features and produce a sequence of digital frames corresponding to those features; and
the processor being adapted to yield location information by comparing frames from the sequence.

19. The pen and printer of claim 17, wherein:
the tip further comprises a ball for depositing ink; and
the position-locating system obtains a sequence of images of an ink surface on the ball and extracts location information and path information from the sequence.

20. The pen and printer of claim 17, wherein:
the path information comprises an initiation point and a termination point and the initiation point and the termination point of the path are determined from data provided by the position-locating system.
